(19) United States
(12) Patent Application Publication
(10) Pub. No.: US 2019/0234451 A1
(43) Pub. Date: Aug. 1, 2019

(54) METHOD AND SYSTEM FOR ACCESSING PIPELINE BEYOND P-TRAP

(71) Applicant: Picote Solutions Inc., Sammamish, WA (US)

(72) Inventor: Mika Lokkinen, Tallinn (EE)

(21) Appl. No.: 15/885,889

(22) Filed: Feb. 1, 2018

(51) Int. Cl. F16C 1/06; F16L 55/26; F16L 55/18; F16L 55/30; F16L 41/04; B65H 75/40; B65H 75/44

(52) U.S. Cl. CPC F16C 1/06; F16L 55/265; F16L 55/18; F16L 55/30; B65H 2701/33; B65H 75/403; B65H 75/4468; B65H 75/4486; F16L 41/04

(57) ABSTRACT

The method concerns accessing an interior of a pipeline that has a P-trap. A tool attached to an end of a flexible metal shaft is provided that is at least partially inside a convoluted tube made of a fluoropolymer material. The tool is pushed into the pipeline through the P-trap by gripping the tube and pushing the tube into the pipeline. The system includes the shaft, the tube and a power transmission device that has a motor for rotating the shaft inside the tube.

### FIELD OF THE INVENTION

The invention relates to a system and method of accessing interior of a pipeline comprising a P-trap.

### BACKGROUND AND SUMMARY OF THE INVENTION

Pipes, such as water and sewage pipes, approaching the end of their service life may be renovated e.g. by lining or coating the inside of an old pipe or by mounting a new pipe into an old pipe. An epoxy resin-impregnated polyester liner, for example, that is inverted into a pipe to be renovated using compressed air, steam or water can be used in lining. After inversion of the liner into the pipe, excess pressure is maintained inside the liner until the epoxy resin cures to its shape conforming to the walls of the old pipe. Modern technology allows even highly complex pipes to be lined.

One of the problems associated with the lining of pipes is reinstating connections of a pipeline after a pipe is lined with a liner. For example, if a main pipe is lined, all connections will be blocked by the liner, e.g. lateral pipes connecting to the main pipe. The connecting lateral pipes are difficult to detect from inside the liner of the main pipe so it would be easier to reinstate the connections from the lateral pipes to the main line. However, a P-trap having a 90 degree bend followed by a 180 degree bend is typically installed in a lateral pipe and it poses a significant challenge to access the connection through the P-trap with a rotating tool. Typically this has been circumvented by reinstating the connections with a robot cutter operating within the main pipe. That method is both slow and uncertain because the connections are difficult to detect.

It is an object of the present invention to present a method and a system that is capable of accessing an interior of a pipeline with a rotatable tool beyond a P-trap in the pipeline.

### BRIEF DESCRIPTION OF THE DRAWINGS

In the following, the present invention is described in greater detail by means of preferred embodiments with reference to the accompanying drawings, in which

FIGS. 1A to 10 illustrate steps of a method according to an embodiment of the present invention;

FIG. 2 shows an isometric view of a system according to an embodiment of the present invention;

FIG. 3 shows a side view of a system according to an embodiment of the present invention; and

FIG. 4 shows a top view of a system according to an embodiment of the present invention.

### DETAILED DESCRIPTION OF THE INVENTION

A first aspect of the present invention is a method of accessing interior of a pipeline comprising a P-trap. A P-trap is a pipe segment, typically having a 180 degree bend next to a 90 degree bend, configured to prevent flowing of gases through the P-trap by trapping water into the P-trap.

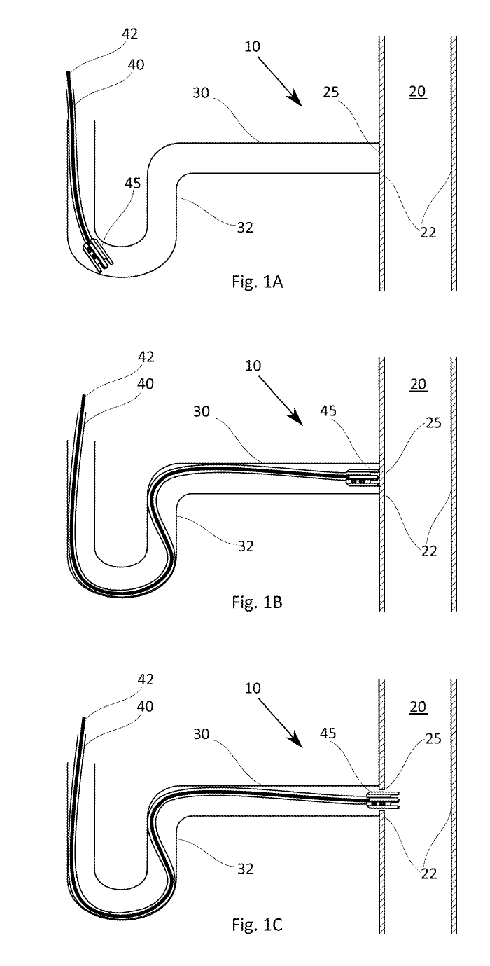

FIGS. 1A to 1C illustrate different phases in the method. FIG. 1A shows a lateral pipe 30 with a connection 25 to a main pipe 20. The lateral pipe 30 can be for example 50 mm or 2 inches in diameter. The main pipe 20 can have the same or larger diameter than the lateral pipe 30. The connection 25 is blocked by a liner 22 because the main pipe 20 has been lined and the connection 25 has not been reinstated. The lateral pipe 30 comprises a P-trap 32. A tool 45 has been inserted in to the lateral pipe 30. The tool 45 is in the 180 degree bend of the P-trap 32 in FIG. 1A. The tool 45 is, for example, a rotatable cutter which is attached to a shaft 42 inside a tube 40. Both, the shaft 42 and the tube 40 are flexible. The tube 40 is not attached to the tool 45 or the shaft 42, thus the tube does not rotate when the shaft and the tool are rotated.

The P-trap 32 has consecutive tight bends which set a requirement for a bend radius of the shaft 42 and the tube 40 surrounding the shaft 42. A small bend radius of the shaft and the tube within the P-trap section increases friction between the shaft and the tube when the shaft rotates inside the tube.

This friction transforms mechanical energy of the rotation into thermal energy which increases temperature of the shaft and the tube. Any surface roughness of the shaft also causes abrasion of the tube from the inside as the shaft rotates against the inner surface of the tube. Typically rotation speeds from several hundred revolutions per minute to more than one thousand revolutions per minute are required for the tool 45 to function properly. Temperature tends to rise so high that it would require a metal tube to withstand the temperature.

The shaft 42 is a flexible shaft, preferably comprising layers of steel wire and alternate layers being wound in opposite directions to provide flexibility. For a lateral pipe having a diameter of about 50 mm, a suitable diameter of the shaft 42 is at least 6 mm and/or at most 10 mm, preferably about 8 mm or about 7 mm to 9 mm. For lateral pipes and P-traps having a larger diameter, such as 75 mm or 100 mm (or 3 inch or 4 inch), a shaft having a diameter of at least 6 mm and/or at most 14 mm can be used.

A tube with a convoluted surface is more difficult to push into the lateral pipe than a tube with a smooth surface but the inventor has found surprising effects when using a convoluted PTFE tube as the tube 40. The PTFE (polytetrafluoroethylene) material itself has a low coefficient of friction and the convoluted structure significantly reduces contact area between the shaft and the tube. In addition, melting point of PTFE is about 327 degrees Celsius which is high enough to withstand the temperatures caused by the friction between the shaft and the tube. In addition, convoluted structure enables small minimum bend radius. The minimum bend radius is preferable at most 30 mm or at most 25 mm. Either melting point or continuous service temperature (maximum operating temperature) is preferably at least 150 degrees Celsius and more preferably at least 180 degrees Celsius or 200 degrees Celsius. Also FEP (fluorinated ethylene propylene) material is suitable for this purpose as it has a melting point of 260 degrees Celsius and maximum operating temperature of 204 degrees Celsius. Also PFA (perfluoroalkoxy alkane) material could be suitable for this purpose as it has a melting point of 315 degrees Celsius and maximum operating temperature of 260 degrees Celsius. In addition, tubes made of other fluoropolymers can also be used. The minimum inner diameter of the tube 40 is preferably from about 1 mm to about 2 mm larger than the diameter of the shaft 42. The maximum outer diameter of the tube 40 is preferably for about 2 mm to about 5 mm larger than the minimum inner diameter of tube 40, i.e. the maximum thickness of the tube is from about 2 mm to about 5 mm. Preferably, the tube has one to five convolutions per centimeter, more preferably 2 to 4 convolutions per centimeter.

Suitable tubes are available from Zeus Industrial Protubes, Inc., such as Convoluted High Performance Flexible Tubing protubes named “PTFE Standard Flex Convoluted”, “PTFE Extra Flex Convoluted”, “FEP Standard Flex Convoluted” and “FEP Extra Flex Convoluted”. For a P-trap having about 50 mm pipe diameter and a shaft of about 8 mm in diameter, suitable part numbers of said protubes are:

ZCT-TS-024 for PTFE Standard Flex Convoluted,

ZCT-TE-024 for PTFE Extra Flex Convoluted,

ZCT-FS-024 for FEP Standard Flex Convoluted, and

ZCT-FE-024 for FEP Extra Flex Convoluted.

Minimum inner diameter for the named protubes is 9.246 mm (except 9.119 for FEP Extra Flex Convoluted) and maximum outer diameter is 13.462 mm for the PTFE tubing and 12.954 mm for the FEP tubing. Minimum bend radiuses are the following:

ZCT-TS-024, Min. bend radius 1.000 inch (25.400 mm)

ZCT-TE-024, Min. bend radius 0.500 inch (12.700 mm)

ZCT-FS-024, Min. bend radius 0.875 inch (22.225 mm)

ZCT-FE-024, Min. bend radius 0.500 inch (12.700 mm)

In the situation shown in FIG. 1A, the tool 45 attached to the shaft 42 having a tube 40 around the shaft, has been inserted in to the lateral pipe 30 and the tool has entered the P-trap 32 of the lateral line. The tool 45 is then pushed forward towards the connection 25 which is currently blocked by the liner 22 of the main pipe 20. The pushing of the tool can be performed by gripping the tube 40 with hands and pushing it forward into the lateral pipe 30. The tube is stiff enough in longitudinal direction so that it pushes the tool 45 forward when the tube is pushed forward. Dimensions of the tool 45 have to be small enough so that it can easily travel through the lateral pipe, especially the P-trap section.

FIG. 1B shows a situation after pushing the tool 45 forward until it reaches the connection 25 to the main pipe 20 at the distal end of the lateral pipe 30. If the tool 45 stops moving forward in the P-trap section or other parts of the lateral pipe when pushing the tube into the lateral pipe, the shaft can be briefly rotated or the tube can be pulled back and forth a few times. This usually helps the tool to pass any minor obstacles, such as pipe joints, in the lateral pipe.

Rotation of the shaft 42 can begin when the tool 45 is in the position shown in FIG. 1B. Rotation of the shaft rotates the tool 45 which is positioned against the liner 22 blocking the connection 25. The tool 45 has one or more cutters on an end of the tool, opposite to the end to which the shaft 42 is attached, i.e. at the end facing the liner 22 in the position of FIG. 1B. For example a device disclosed in U.S. patent application Ser. No. 14/358,729 (Lokkinen et al) can be used as the tool 45. The tool 45 can be a grinding device comprising at least one cutter, a body and fastening means for fastening the grinding device to a rotation shaft, the grinding device being movable both in a forward direction and in a direction transverse to the forward direction, the body and the at least one cutter having a forward end extending beyond the body for grinding pipe renovation material (i.e. liner 22) in the forward direction of the grinding device and the at least one cutter having a side portion extending radially outwardly from the body for grinding pipe renovation material (i.e. liner 22) in the direction transverse to the forward direction. Also other suitable devices can be used as the tool 45.

Rotation of the shaft 42 and the tool 45 while pushing those gently forward by pushing the tube 40 forward cuts away the liner 22 blocking the connection 25. After a while, the tool 45 penetrates the liner 22 and creates a hole in the liner 22 and thereby reinstates the connection 25 from the lateral pipe 30 to the main pipe 20. When the reinstating is performed from the lateral pipe 30 into the main pipe 20, the hole made in the liner 22 with the tool 45 is always located in the connection area. This is not the case if the reinstatement is made from the main pipe 20 into the lateral pipe 30.

The reinstated connection 25 is enlarged to about the diameter of the lateral pipe 30 by rotating the tool 45 in the hole in the liner 22 as shown in FIG. 1C. The tool 45 enlarges the hole by grinding the liner with the side portion of the cutter of the tool 45. When the hole in the liner 22 has been enlarged to about the size of the lateral pipe 30, the tool 45 can be removed from the lateral pipe 30 by pulling from the tube 40. This also removes the shaft 42 and the tube 40 from the pipe. Now that the connection 25 has been successfully reinstated, the lateral pipe 30 can be lined with a liner.

A second aspect of the invention is a system for accessing interior of a pipeline comprising a P-trap. A P-trap is a pipe segment, typically having a 180 degree bend next to a 90 degree bend, configured to prevent flowing of gases through the P-trap by trapping water into the P-trap.

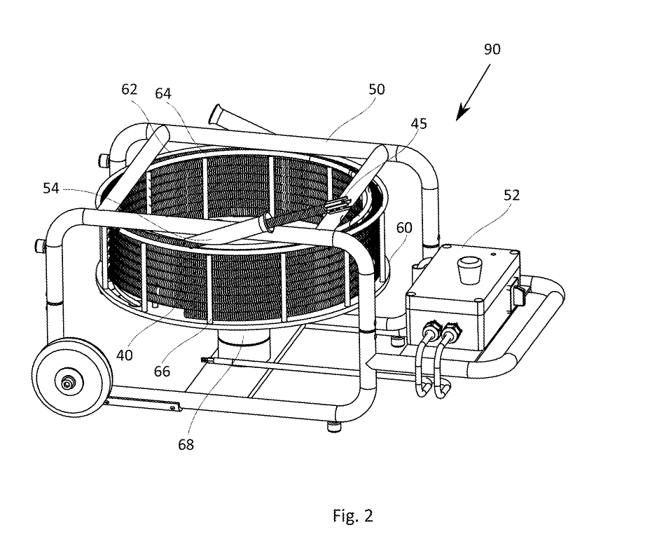

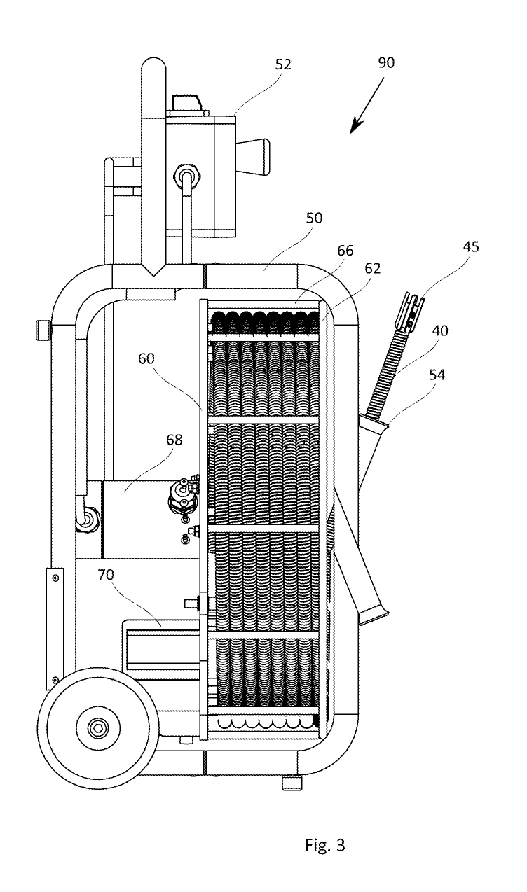

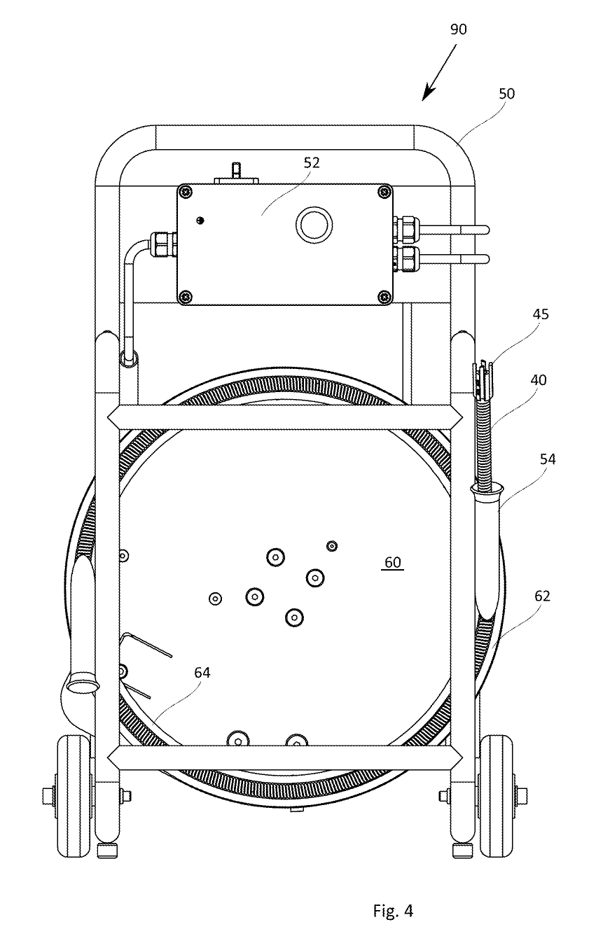

FIGS. 2 to 4 show the system which comprises a power transmission device 90, a shaft 42, and a tube 40 at least partially surrounding the shaft, and a tool 45 configured to be attached to the shaft 42. The shaft 42, the tube 40 and the tool 45 are similar to what has been described in first aspect of the invention related to a method of accessing interior of a pipeline comprising a P-trap.

The power transmission device 90 comprises a reel 60 into which the shaft 42 with its tube 40 can be reeled, a guide 54 for feeding the shaft 42 with its tube 40 onto and/or off from the reel 60, and a motor 70 in connection with the head end of the shaft for rotating the shaft. The motor 70 is preferably attached to the reel 60 and arranged to rotate along with the reel 60.

The power transmission device 90 comprises a frame 50, which is preferably light and durable, for example, made of metal pipes or metal bars. The frame is preferably carriage-like and equipped with wheels. The reel 60 is connected to the frame with an axle 68 with bearings or a sliding surface which allows the reel to be rotated in relation to the frame.

With the exception of its exposed ends, the shaft 42 is inside the tube 40, within which the shaft 42 is able to rotate as needed. One of the exposed ends of shaft 42 is attached to the motor 70 and the opposite end is attached to the tool 45. Preferably the shaft 42 travels through the guide 54, which is, for example, a pipe or a loop made from a pipe or bar. As the motor 70 rotates the head end of the shaft 42, the torsionally rigid shaft within the tube 40 rotates and, at the same time, rotates a tool 45 attached to the tail end of the shaft 42. In connection with the head end of the shaft, there is preferably a safety switch, which breaks or opens if torsion grows too high, for example, as a result of the shaft becoming jammed. The safety switch prevents additional damage by disconnecting the shaft from the motor. Disconnection may be implemented by physically detaching the shaft from the motor 70 or preferably by preventing the transmission of the rotational movement of the motor or a part thereof to the shaft 42. The motor 70 is preferably an electric motor but also pneumatic or hydraulic motors can be used.

In an operating position shown in FIG. 2, the axle 68 is substantially perpendicular in relation to the ground, floor or other base, onto which the device 90 is placed for operation, wherein feeding of the shaft 42 with its tube 40 onto the reel 60 and off the reel 60 is easily accomplished. The axle 68 can be bearing-mounted to make the reel 60 rotate more easily.

Preferably, the reel 60 comprises an outer ring 62 and an inner ring 64. The shaft 42 with its tube 40 can be reeled into the space between the inner and outer rings. The difference between the radii of the outer ring 62 and the inner ring 64 of the reel 60 is less than double in relation to the outer diameter of the tube 40. Thus, two layers of tube 40 cannot fit side-by-side but a tube 40 being reeled in always sets on top of the previous layer. Thus, the tube 40 cannot become jammed onto the reel but it moves easily onto the reel 60 and can also be easily pulled off the reel 60. The combination of the shaft 42 and tube 40 is preferably rigid enough that, as it is pushed onto the reel 60, the reel 60 rotates in response to the shaft 42 being pushed onto the reel 60. This makes the system especially easy to use and enables a single person to operate the system, even at some distance from the frame 50 and reel 60 themselves. The inner ring 64 and outer ring 62 of the reel have preferably rungs 66 that keep the shaft 42 and tube 40 substantially between the inner and outer rings. In place of the rungs 66, a plate-like solution may also be used.

It is obvious to the person skilled in the art that, due to the illustrative clarity of the description, the exemplified embodiments presented above are relatively simple both in structure and function. Following the concept presented in this patent application, it is possible to construct solutions, which are different and quite complicated and which utilize the inventive concept presented in this patent application.

I claim:

1. A method of accessing interior of a pipeline comprising a P-trap, comprising:
providing a tool attached to an end of a flexible metal shaft that is at least partially inside a convoluted tube made of a fluoropolymer material, the tool and the flexible metal shaft being rotatable in relation to the convoluted tube, and
pushing the tool into the pipeline through the P-trap by gripping the tube and pushing the tube into the pipeline.

2. The method of claim 1, wherein said convoluted tube is made of a fluoropolymer material having a melting point of 200 degrees Celsius or higher.

3. The method of claim 1, wherein said convoluted tube is made of polytetrafluoroethylene (PTFE) or fluorinated ethylene propylene (FEP).

4. The method of claim 1, wherein said flexible metal shaft comprises layers of steel wire and alternate layers are wound in opposite directions.

5. The method of claim 1, wherein said flexible metal shaft has a diameter of at least 6 mm and at most 14 mm.

6. The method of claim 1, wherein said convoluted tube has a minimum inner diameter of at least 1 mm larger than the diameter of the flexible metal shaft and at most 2 mm larger than the diameter of the flexible metal shaft.

7. The method of claim 1, wherein said convoluted tube has one to five convolutions per centimeter.

8. A system for accessing interior of a pipeline comprising a P-trap, comprising:
a flexible metal shaft at least partially disposed inside a convoluted tube made of a fluoropolymer material, and
a power transmission device having a reel arranged to be rotated, into which the tube of the shaft is reelable, and a motor in connection with a head end of the shaft for rotating the shaft in relation to the tube.

9. The system of claim 8, wherein the motor of the power transmission device is attached to the reel and arranged to rotate along to the reel.
